(19) United States
(12) Patent Application Publication
(10) Pub. No.: US 2025/0310364 A1
(43) Pub. Date: Oct. 2, 2025

(54) METHODS FOR APPLICATION SECURITY TESTING

(71) Applicant: MICROSOFT TECHNOLOGY LICENSING, LLC, Redmond, WA (US)

(72) Inventors: Jason Todd GEFFNER, Redmond, WA (US); Jeromy S. STATIA, Arlington, WA (US)

(21) Appl. No.: 18/896,729

(22) Filed: Sep. 25, 2024

Related U.S. Application Data
(60) Provisional application No. 63/571,425, filed on Mar. 28, 2024.

(51) Int. Cl. H04L 9/40

(52) U.S. Cl. CPC H04L 63/1425; H04L 63/1433

(57) ABSTRACT

The disclosed techniques improve security testing of remote services. To improve coverage, a complete list of endpoints exposed by a service are identified. In some configurations, route objects that map request URLs to services are analyzed in-memory to identify endpoints. Test coverage is also improved at runtime by enabling a dynamic testing tool to access service endpoints without login credentials. In some configurations, code is injected into a live service process that bypasses an authorization component of a request handling pipeline. In some configurations, testing is improved by locating test clients on the servers being tested.

### PRIORITY APPLICATION

The present application is a non-provisional application of, and claims priority to, U.S. Provisional Application Ser. No. 63/571,425 filed on Mar. 28, 2024, entitled: METHODS FOR APPLICATION SECURITY TESTING, the contents of which are hereby incorporated by reference in their entirety.

### BACKGROUND

Remotely hosted software services are often targeted by hackers. If a service is compromised a hacker may be able to steal data, disrupt operations, tarnish reputations, perform espionage, etc. To combat this threat, remotely hosted software services are protected by multiple security procedures. One technique is Dynamic Application Security Testing (DAST), which identifies vulnerabilities while the service is running. For example, a runtime security analysis tool may connect to endpoints provided by a service, supply them with parameters, and analyze their return values to identify security vulnerabilities. However, the complete list of service endpoints and their parameters is not always known or well documented, limiting the effectiveness of this type of analysis.

One existing technique for identifying endpoints exposed by a service is to scan the service's source code. However, the source code of a service is not always available, and when it is, service endpoints may be defined in non-standard ways that are difficult to detect. This technique also fails to identify dynamically named endpoints or endpoints that were installed surreptitiously. Another technique for identifying endpoints is to query the service itself. Some services expose an endpoint that self-describes other endpoints provided by the service. However, these lists may be intentionally or unintentionally incomplete. Another technique for identifying endpoints—spidering—is to find references to them across the internet. While spidering does discover many services and endpoints, it is limited to services and endpoints referenced by web pages. Furthermore, of the endpoints it does identify, it does not always identify a complete list of API parameters, limiting the effectiveness of runtime testing. Regardless of why a service, endpoint, or API parameter is undiscovered, failing to comprehensively test all exposed endpoints leaves a service more vulnerable to attack.

Another obstacle to effective runtime analysis of a service is access control. Typically, users are authenticated before being authorized to use a service. Unauthorized users are often unable to exercise some of the functionality of a target service, if they can access it at all. Individual organizations may be able to authorize a user account to access a service on an ad-hoc basis. However, it is impractical to obtain and securely manage these credentials at scale. These challenges to managing and providing user credentials prevent runtime analysis of services en-masse, such as a cloud service provider scanning the services they host for security vulnerabilities.

Other challenges to performing a runtime analysis of a service, particularly at scale, are cost, efficiency, and data privacy. Analyzing a large number of service endpoints entails transmitting a large number of requests and receiving a large number of responses over physical network infrastructure. This can entail a significant number of computing devices and network bandwidth. In addition to the financial and energy costs, retrieving and aggregating data from service endpoints has the potential to centralized sensitive user data, amplifying a potential data breach.

It is with respect to these and other considerations that the disclosure made herein is presented.

### SUMMARY

The disclosed techniques improve security testing of remote services. To improve coverage, a complete list of endpoints exposed by a service are identified. The list of endpoints may be exported in a standardized specification format, such as formats compatible Swagger or OpenAPI. In some configurations, route objects that map request URLs to services are analyzed in-memory to identify endpoints. Test coverage is also improved at runtime by enabling a dynamic testing tool to access service endpoints without login credentials. In some configurations, code is injected into a live service process that bypasses an authorization component of a request handling pipeline. In some configurations, testing is improved by locating test clients on the servers being tested.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates objects stored in a memory of a cloud-hosted service.

FIG. 2 illustrates a route object routing an HTTP request to an endpoint.

FIG. 3 illustrates a dynamic security analyzer sending a synthetic HTTP request to a service under test.

FIG. 4 illustrates how a web request may be processed by a web request pipeline.

FIG. 5 illustrates replacing an authorization component of a web request pipeline with an authorization hook.

FIG. 6 illustrates replacing an authentication component of a web request pipeline with an authentication hook.

FIG. 7 illustrates co-locating a dynamic web service test client on the same computing device running the service under test.

FIG. 8 is a flow diagram of an example method for dynamic discovery of web service routes.

FIG. 9 is a flow diagram of an example method for transparent authorization.

FIG. 10 is a flow diagram of an example method for accelerated dynamic security testing.

FIG. 11 is a computer architecture diagram illustrating an illustrative computer hardware and software architecture for a computing system capable of implementing aspects of the techniques and technologies presented herein.

### DETAILED DESCRIPTION

The disclosed techniques identify software service endpoints running on a computing device. An endpoint represents a piece of functionality exposed by a service. In the context of web services an endpoint is often identified by a URL. A path of the URL typically represents the resource or a group of resources that the request is intended to interact with. For example, a URL that ends with the path ‘/users’ suggests that the endpoint targets the users resource of the web service.

Service endpoints may be cataloged for a number of reasons, including comprehensive security scans, functional testing, and load testing. For example, a list of service endpoints may be consumed by tools such as READYAPI and SCHEMATHESIS that automatically and dynamically validate a web service's schema rules, perform load testing, and evaluate response time performance. In some configurations, a service owner may engage a dynamic security scan to enumerate service endpoints. For example, the service owner may wish to learn if any service endpoints have been surreptitiously or accidentally exposed.

In some configurations, a route object is a software module that identifies a service endpoint and any parameters from a URL. The route object is typically found in the working memory of the service. A route object may also map a request to a request handler—the software that implements the service. In the context of a web service, a route object maps URL address path segments, HTTP methods, and/or HTTP header values to request handlers.

Some web services identify a service endpoint from a combination of path segment(s), HTTP method, and/or HTTP header values. However, other techniques for routing an HTTP request to a particular service endpoint are similarly contemplated. Some service protocols, such as gRPC, map HTTP requests to endpoints without the concept of routing.

The disclosed techniques also enable broad-based dynamic testing on service endpoints by bypassing security measures. In some scenarios this dynamic testing is performed at the behest of individual service owners, while in other scenarios dynamic testing is performed by the cloud service operator on a number of services. In some configurations, one or more security components of the service are selectively disabled based on whether a request originates from a dynamic testing tool. For example, an authorization requirement of a service, ordinarily a cornerstone of runtime security and access management, may be disabled temporarily in order for a dynamic testing tool to test the service. In some configurations the security component is disabled by the cloud service operator that is hosting the service, not an owner of the service. This allows the cloud service provider to test a number of services of a number of owners without the impractical task of obtaining and managing credentials of each service.

In some configurations, an authorization component of a request handling pipeline is bypassed. A service is often implemented with a request handling pipeline that processes requests in stages. As a simplified example, a web service may process a web request by applying an HTTP redirect component, followed by a routing component, followed by an authentication component, followed by an authorization component, followed by a request handler. In some configurations, the authorization and/or authentication components are selectively bypassed based on whether a request originates from a dynamic testing tool.

In some configurations, code injected into a live service bypasses the authorization component of the request handling pipeline. For example, the injected code may install an authorization hook that intercepts requests made to the actual authorization component, taking its place in the request handling pipeline. When invoked, the authorization hook analyzes properties of the request to determine whether to allow the request without authorization credential or whether to forward the request to the actual authorization component. Requests determined to originate from a dynamic testing tool are forwarded to the next component of the request handling pipeline, while requests determined not to originate from a dynamic testing tool are forwarded to the original authorization. An authentication hook may similarly be installed to selectively bypass the actual authentication component, among other components of the request handling pipeline.

The disclosed techniques also improve the cost, energy, and time efficiency of dynamic service analysis by co-locating a test client on the same computing device that runs the service under test. Dynamic testing such as dynamic web security testing is traditionally performed by test clients that submit requests over a physical network to remote servers. Submitting requests from a remove device has some benefits, such as not needing permission to execute code on the servers under test, and by more closely approximating real world conditions. However, there are significant downsides to this architecture, such as the additional cost of the computing devices used to run the test clients, the additional cost of networking bandwidth needed to invoke the services, and the potential for user data to be transmitted over the network and stored in a less secure manner.

To address these and other issues, test clients are executed on the server devices that run the services under test. Co-locating with the service under test reduces cost, improves the speed at which testing can be performed and/or reduces the computational burden imposed by testing. Co-locating with the service under test also keeps potentially sensitive user data local, reducing the exposure of potentially sensitive user data.

### Automated Discovery of API Endpoints

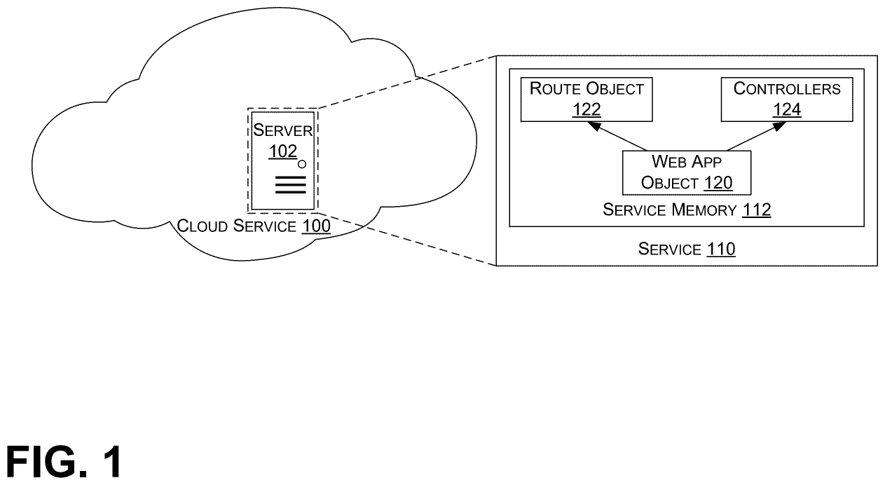

FIG. 1 illustrates objects stored in a memory of a cloud-hosted service. Cloud service 100 hosts server 102. Server 102 is an example of an individual server computing device hosted by cloud service 100, representative of thousands or more server computing devices that are hosted by cloud service 100 at any given time. Service 110 runs on server 102. Service 110 may be a web service hosted by a web server, a remote procedure call (RPC) service hosted by an RPC server, or the like. Remotely invocable services like service 110 are commonly used to submit or retrieve data, engage in commerce, facilitate online video games, among other applications. FIG. 1 illustrates a service running on a server in a cloud environment, but the disclosed embodiments may be applied to a service running on any device in any environment.

Service 110 includes service memory 112—a representation of a portion of main memory of server 102 that has been allocated to service 110. Service memory 112 may include operating system components, web server components, third party components, among other executable modules and data. Service memory 112 may be random access memory, flash memory, or any other type of memory that stores service 110 as it executes.

Service memory 112 includes web application object 120, which represents a root object of service 110. For example, web application object 120 of an ASP.NET Model View Controller (MVC) web service is the Application object—an object that is globally accessible and which can be used to find relevant functionality and data when responding to an HTTP request. In some configurations, web application object 120 may be a starting point for finding route object 122, controllers 124, or other in-memory objects of service 110. For example, web application object 120 may be the root of a hierarchy of objects. This hierarchy may be traversed to identify route object 122, controller 124, or other components of service 110. Additionally, or alternatively, route objects 122 and other objects that indicate how a request is mapped to an endpoint may be found in memory 112 directly, without beginning a traversal at a root object such as web application object 120.

As illustrated, web application object 120 references route object 122. Route object 122 may be one of a number of route objects associated with service 110. Route objects are used to determine which request handler of service 110 will process a particular HTTP request, and how URL path segments and HTTP headers and data found in an HTTP body are provided to the request handler as function parameters. For example, when looking for a request handler for a particular HTTP request, route objects are considered in turn until a match is found.

Web application object 120 also references controllers 124. Controllers 124 are examples of request handlers that may be invoked by route object 122 to respond to an HTTP request. In the MVC architecture, controllers expose actions, which are implemented as methods on a class. Route object 122 may invoke a particular action on a particular controller 124 based on the URL path segments and/or HTTP headers of an HTTP request.

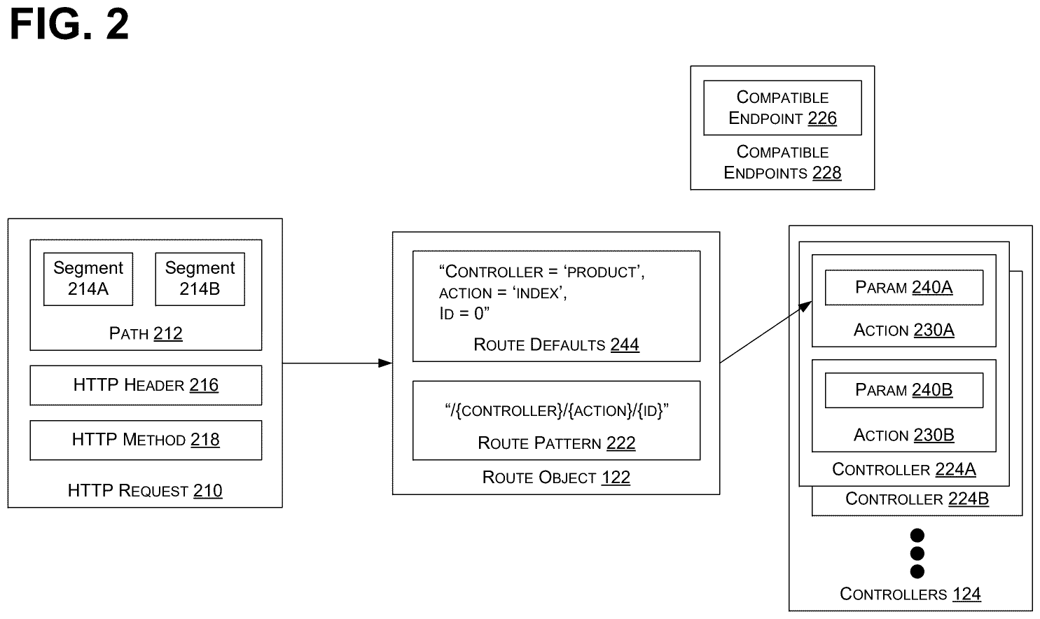

FIG. 2 illustrates a route object routing an HTTP request to an endpoint. Specifically, this example relates to the Model-View-Controller (MVC) web service architecture. However, other types of services are similarly contemplated, including other web service architectures, RESTful web services, gRPC, and non-HTTP based services such as distributed component object model (DCOM).

For example, gRPC uses protocol buffers, and so mappings from URLs to endpoints may be obtained by locating “proto” files that contain a service interface, or the in-memory equivalent, to determine how a URL maps to an endpoint. For example, gRPC based endpoints may be defined with a “: path” in the service contract with the pattern “/package. Service/Method”, where package is the package name, Service is the name of the gRPC service, and Method is the method to be invoked. The memory of a gRPC based service may be searched for packages, their Services, and the Methods of those Services to enumerate available endpoints.

Other types of web application frameworks may directly map a URL path to a particular implementation. For example, RESTful frameworks may map a combination of HTTP method (such as GET or POST) and URL path to an implementation of the endpoint. The memory of a RESTful web service may be scanned for objects that detail these mappings, thereby enumerating the possible endpoints of the web service.

Continuing with the MVC example, HTTP request 210 includes URL path 212, which may be constructed of path segments 214. HTTP request 210 also includes HTTP header 216 and HTTP method 218. URL path 212 is a portion of an HTTP request that comes after the domain name. Often, URL path 212 includes slash-delimited text. Path segments 214 refer to individual slash-delimited portions of path 212.

HTTP request 210 has been determined to match route pattern 222 of route object 122. Route pattern 222 is the result of deconstructing URL path 212 into slash-delimited path segments 214. In this example, the first path segment 214A is used to look up controller 224A of controllers 124. The 2nd path segment 214B is used to determine which action 230 of controller 224A will be invoked. The final path segment—‘ID’—is passed as parameter 240A to the identified action 230A of the identified controller 224A.

In some configurations, one or more route objects 122 of service 110 are enumerated. For example, route objects 122 may be enumerated from a tree of in-memory objects rooted by web application object 120. The enumerated route objects 122 are analyzed to produce a list of reachable endpoints 228 of service 110. This analysis may be performed any time that service 110 is running, independent of any particular request 210.

As referred to herein, an endpoint refers to a URL, often including a path, that is substantively responded to by service 110. URLs that are not responded to by service 110, e.g. by responding with a 404 file not found error, are not included in the list of compatible endpoints 228. A URL is substantively responded to when a route pattern 222 of a route object 122 maps path segments 214 onto a valid action.

Accordingly, a list of compatible endpoints 228 may be generated by determining the permutations of route segments defined by route pattern 222 that result in a valid controller +action pair. A compatible endpoint 226 of the list of compatible endpoints 228 may also indicate how many and what types of parameters are expected by particular actions 230 of the identified endpoints 228.

Route objects 122 map requests 210 to service endpoints 228 in a number of ways. Some route objects 122 hard-code a mapping of a specific path 212 to a particular action 230. In this case, an endpoint 226 is defined by the specific path 212.

Some route objects 122 include a default handler 244 that supplies one or more values that are missing from HTTP request 210. For example, if path 212 omits a filename, route defaults 244 may supply “index.html” as the file to retrieve. In these scenarios, route defaults 244 may be analyzed to determine that “index.html” is a valid endpoint.

Other route objects 122 use path segments 214, HTTP methods 218, and/or HTTP header values 216 as variables, allowing a single route object 122 to define multiple endpoints 228. For example, route object 122 may choose which controller 224 to invoke based on a particular path segment 214 and the value of a particular HTTP header 216. In this configuration, a list of valid endpoints 228 may be obtained by finding the combinations of path segment 214 values, HTTP header 216 values, and HTTP methods 218 that invoke code that returns an HTTP response.

As an example that does not use the MVC architecture, a route object may support remote invocation of functions that accept a single parameter. This route object may deconstruct the HTTP request path into ‘{func}/{param}’, such that the first path segment is used as the function name and the second path segment is used as the value of the parameter passed to the function. At runtime, a path of ‘/get_name/first’ would be identified as being compatible by this route object. The ‘func’ variable would have the value ‘get_name’, while the ‘param’ variable would have the value ‘first’. In this configuration, the list of available endpoints may be determined by enumerating which combinations of path segments 214 map to valid request handlers. For example, if “get_name”, “get_id”, and “get_location” are valid functions that take a single parameter, then “get_name”, “get_id”, and “get_location” would be listed as valid endpoints enabled by this route object.

Continuing the example, in addition to listing the endpoints “get_name”, “get_id”, and “get_location”, these functions may be analyzed to identify their respective parameter names. For example, if the “get_name” function has a parameter “which_name”, then the “get_name” endpoint may be augmented with an indication that it takes a parameter called “which_name”. If “get_name” is implemented in a strongly typed language, then the parameter type may also be inferred, e.g., whether the parameter is expected to be a number, text, a date, etc.

Returning to the MVC architecture, URL paths 212 are mapped to actions 230 exposed by controllers 224. Parameters 240 passed to actions 230 may also be specified by additional path segments 214 or HTTP headers 216. For example, route object 122 may decompose URL path 212 into controller, action, and id values: ‘{controller}/{action}/{id}’. At runtime, the first path segment 214A identifies controller 224A, the second path segment 214B identifies action 230A—a method exposed by controller 224—and the third path segment will be used as a parameter to action 230A. Additional path segments may map to additional parameters of the action.

Valid endpoints may be enumerated for this type of MVC route object by searching the service's memory for available controllers 224, searching these controllers for available actions 230, and searching the available actions 230 for parameters 240. In some configurations, lists of controllers, their actions, and their parameters are pre-computed and can be scanned directly once found in memory.

In other configurations, controllers, actions, and parameters may be identified by traversing in-memory objects and using runtime inspection and manipulation of code and data to find their names and values. Reflection is an example of runtime inspection and manipulation of code and data that allows programmatic inspection of an object's type and values at runtime. For example, reflection allows the fields of an object to be enumerated at runtime, and the values of those fields to be obtained. Reflection may be used recursively to locate route objects 122 from web application object 120. For example, reflection may be used to locate a field of web application object 120 that lists route objects 122. The field that lists route objects 122 may be identified by name, such as “Routes”, or by type, such as having the type “RouteList”. Reflection may again be used on the list of route objects to access individual route objects 122. For example, reflection may be used to walk through the list of route objects in memory. Reflection may then be used on each route object 122 to obtain route patterns 222. For example, reflection may be used to obtain one or more values of fields that describe route patterns 222.

This example of listing route objects 122 is just one example of an object hierarchy-other object hierarchies and other types of traversals are similarly contemplated. For platforms that do not support reflection, in-memory traversal may be performed by directly inspecting memory locations to determine the names of controllers, actions, or other constructs that are executed in response to a request.

The disclosed endpoint discovery techniques do not require source code access. These techniques may be applied to any service that is accessed remotely, including web sites, traditional web services, RESTful web services, and Remote Procedure Calls (RPC). For instance, endpoints are discovered for a web application built using the Model-View-Controller (MVC) architecture as effectively as endpoints are discovered for gRPC based services. Similarly, endpoint discovery is agnostic to the underlying server technology, making it equally adapted to Apache, Nginx, ASP.NET.

Service memory 112 may be accessed as service 110 operates. For example, a debugging API or a profiling API may be used to access service memory 112 on an active server. Additionally, or alternatively, service memory 112 may be a snapshot of the working memory of service 110.

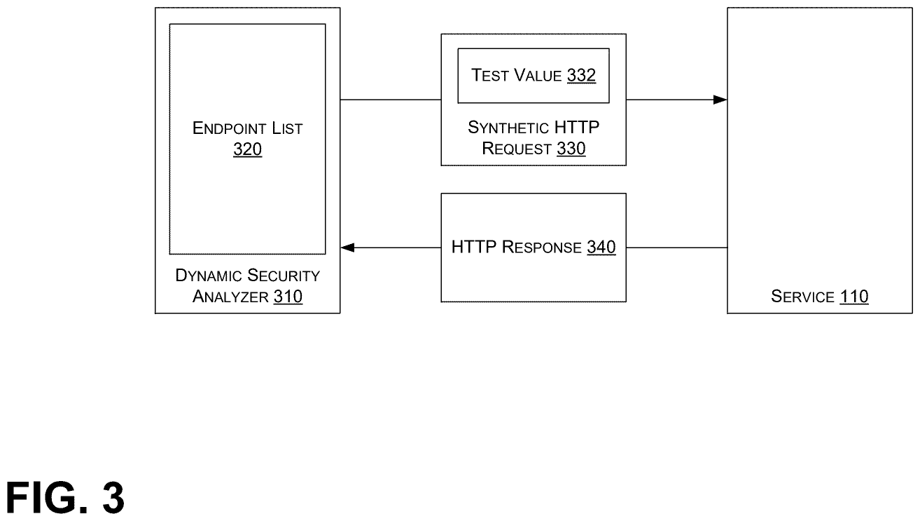

FIG. 3 illustrates a dynamic security analyzer sending a synthetic HTTP request to a service under test. Dynamic security analyzer 310, which is one example of a live dynamic test that can be performed on service 110, has access to or has incorporated endpoint list 320. Endpoint list 320 includes a list of endpoints enumerated by reflection or similar technique described above in conjunction with FIG. 2. When constructing a synthetic HTTP request 330 for testing service 110, endpoint list 320 may be referenced to determine one or more endpoints exposed by service 110 and their parameters. For example, synthetic HTTP request 330 may include test value 332 based on the data type of a parameter listed in endpoint list 320.

Service 110 responds to HTTP request 330 with HTTP response 340. HTTP response 340 may include response data that can be evaluated to determine if there is a security vulnerability in one of the endpoints of service 110.

### Transparent Authorization and/or Authentication

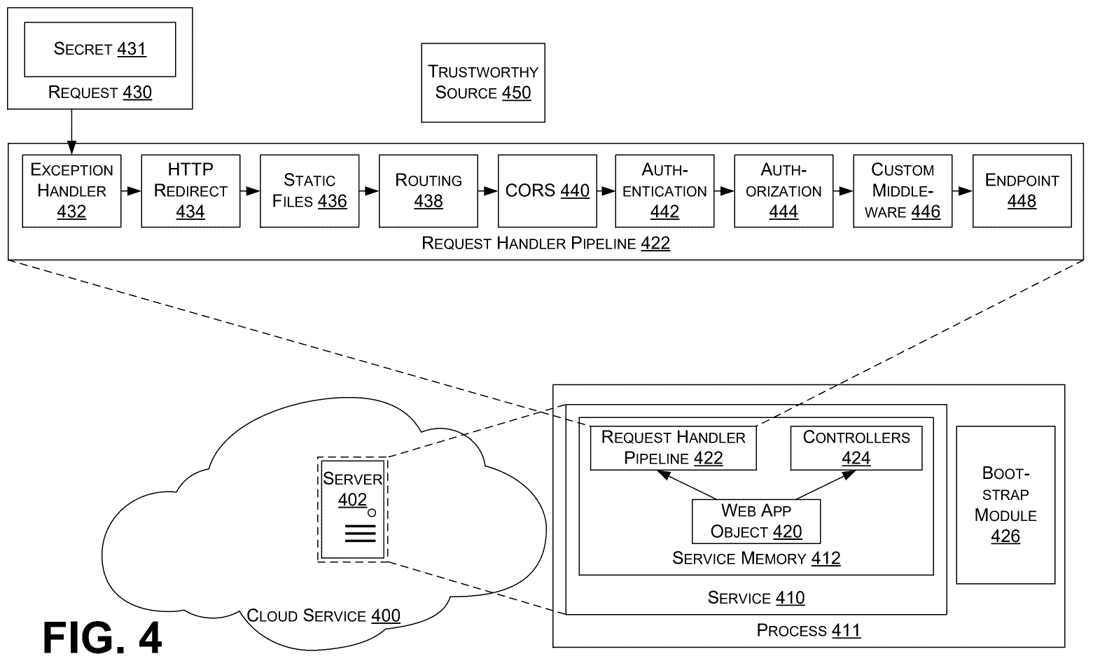

FIG. 4 illustrates how a web request is processed by a web request pipeline. Cloud service 400 hosts server 402, a physical computing device that runs service 410. Service 410 includes service memory 412, a portion of system memory of server 402 that is allocated for the service 410. Service memory 412 includes one or more objects, such as web application object 420. Similar to web application object 120, web application object 420 provides global access to code and data that is usable when responding to a web request. Web application object 420 references one or more controllers 424, which are similar to the controllers 124 discussed above in conjunction with FIG. 1.

Web application object 420 also references request handler pipeline 422. Request handler pipeline 422 is a series of components that call each other in turn, passing request 430 through from exception handler 432 to endpoint 448, in this example. Components along the way may perform actions on request 430 or short-circuit the processing of request 430 without calling a substantive request handler.

While the number and type of components included in request handler pipeline 422 may vary, authentication component 442 and authorization component 444 are relevant to the claimed embodiments. In some configurations, in order to transparently bypass authorization requirements of service 410, authorization component 444 and/or authentication component 442 may be bypassed in response to a determination that request 430 originates from a trustworthy source 450. What constitutes a trustworthy source may be different in different scenarios. One example of a trustworthy source is a dynamic testing application, as is used when performing dynamic application security testing. When constructing HTTP request 430, a dynamic testing application may generate an ephemeral secret 431 with which to verify that HTTP request 430 is trustworthy. The dynamic testing application may include ephemeral secret 431 in an HTTP header of request 430. Ephemeral secret 431 may be provided to hooks that replace authorization component 444 and/or authentication component 442 in order to confirm that request 430 is trustworthy.

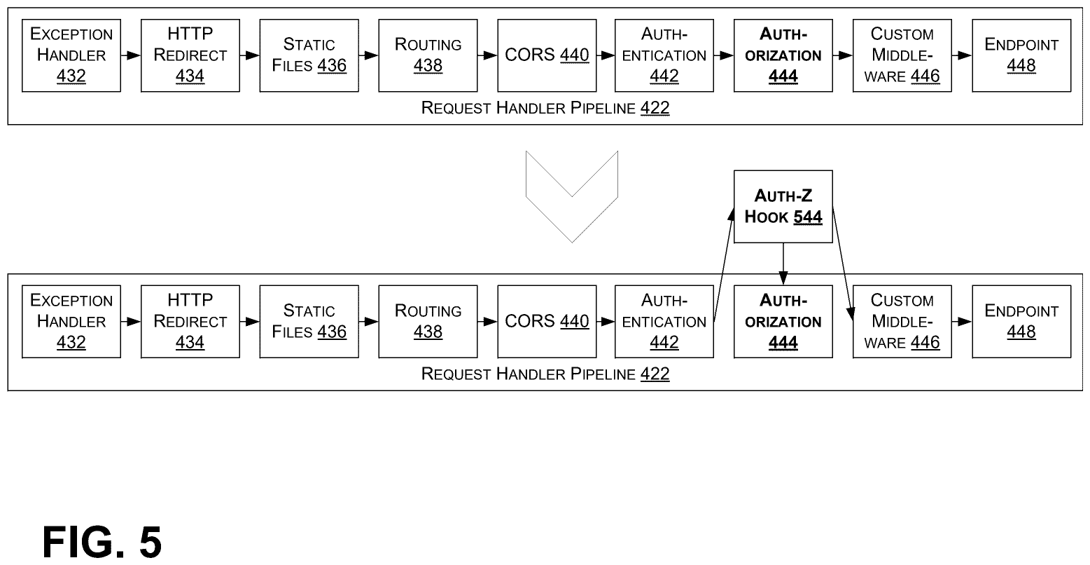

FIG. 5 illustrates replacing an authorization component of a web request pipeline with an authorization hook. Authorization component 444 may be found as service 410 runs by injecting bootstrap module 426 into process 411, which is hosting service 410. Process 411 is an operating system construct that encapsulates and isolates memory. Bootstrap module 426 may be injected by any known technique for injecting code into a live, running process, such as loading a dynamic link library or shared object into process 411. Bootstrap module 426 may search service memory 412 of process 411 for web application objects 420, from which one or more request handler pipelines 422 may be found.

Request handler pipeline 422 may be analyzed by traversing the constituent components until authorization component 444 is located. Components of pipeline 422 may be connected by references—fields of one component that point to another component in memory. Pipeline 422 may be traversed by using references to advance from one component to the next. Once authorization component 444 has been located, authorization hook 544 may be inserted into request handler pipeline 422 in its place. For example, a reference from the preceding component to authorization component 444 may be replaced with a reference to authorization hook 544. In this way, as request handler pipeline 422 processes request 430, request 430 will be forwarded to authorization hook 544 instead of authorization component 444.

Authorization hook 544 may determine whether to skip authorization or whether to forward request 430 to authorization hook 444 for ordinary authorization processing. In some configurations, authorization hook 544 determines whether request 430 comes from trustworthy source 450, and if so, forwards it to a successive component such as custom middleware 446. This has the effect of bypassing the original authorization component 444, providing transparent access to service 410. However, when request 430 cannot be verified as originating from trustworthy source 450, authorization hook 544 forwards request 430 to authorization component 444 to be processed as if no modification to request handler pipeline 422 had taken place.

As discussed above, authorization hook 544 may determine that request 430 originates from trustworthy source 450 by comparing ephemeral secret 431 stored in request 430 with a value received from trusted application 450. For example, in the context of dynamic security scanning of service endpoints, trustworthy source 450 creates request 430 with ephemeral secret 431. Authorization hook 544 may confirm with trustworthy source 450 that ephemeral secret 431 is valid, confirming that authorization should be bypassed.

Additionally, or alternatively, request 430 may be trusted if it is determined to originate from a trusted computing device. In some configurations, an allow list of trusted computing devices is kept and referenced by authorization hook 544 when determining whether to trust request 430. In another configuration, a determination that web request 430 originates from a same network address as server 402 indicates that request 430 is from a trustworthy source.

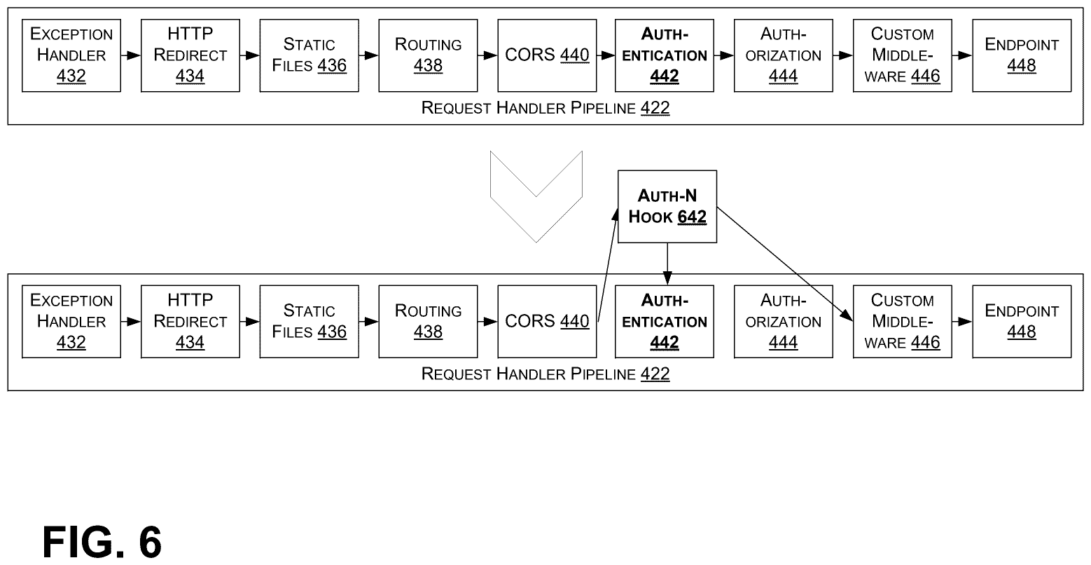

FIG. 6 illustrates replacing an authentication component of a web request pipeline with an authentication hook. Authentication component 442 is located in a manner similar to how authorization component 444 is located, as discussed above in conjunction with FIG. 5. Briefly, a bootstrap module 426 is injected into service 410, where it traverses objects in service memory 412 to find web application object 420 and ultimately request handler pipeline 422. Components of request handler pipeline 422 are then traversed until authentication component 442 is found.

In some configurations, authentication component 442 is replaced in request handler pipeline 422 with authentication hook 642. Similar to how authorization hook 544 was installed, as discussed above, authentication hook 642 may be inserted by replacing a reference from a preceding component to authentication component 442 with a reference to authentication hook 642.

Once installed, authentication hook 642 receives HTTP request 430 from the preceding component. In FIG. 6, the preceding component is CORS 440, but this is just one example and any other type of component is similarly contemplated. Authentication hook 642 may also determine whether HTTP request 430 originated from a trustworthy source 450 using the same or similar techniques that authorization hook 544 uses, as discussed above.

When HTTP request 430 is determined to originate from a trustworthy source 450, authentication hook 642 forwards request 430 directly to custom middleware 446, or whatever component follows authorization component 444 in request handler pipeline 422. However, if authentication hook 642 does not determine that HTTP request 430 originates from a trustworthy source 450, authentication hook 642 provides request 430 to authentication component 442 for continued processing.

### Accelerated Dynamic Application Security Testing

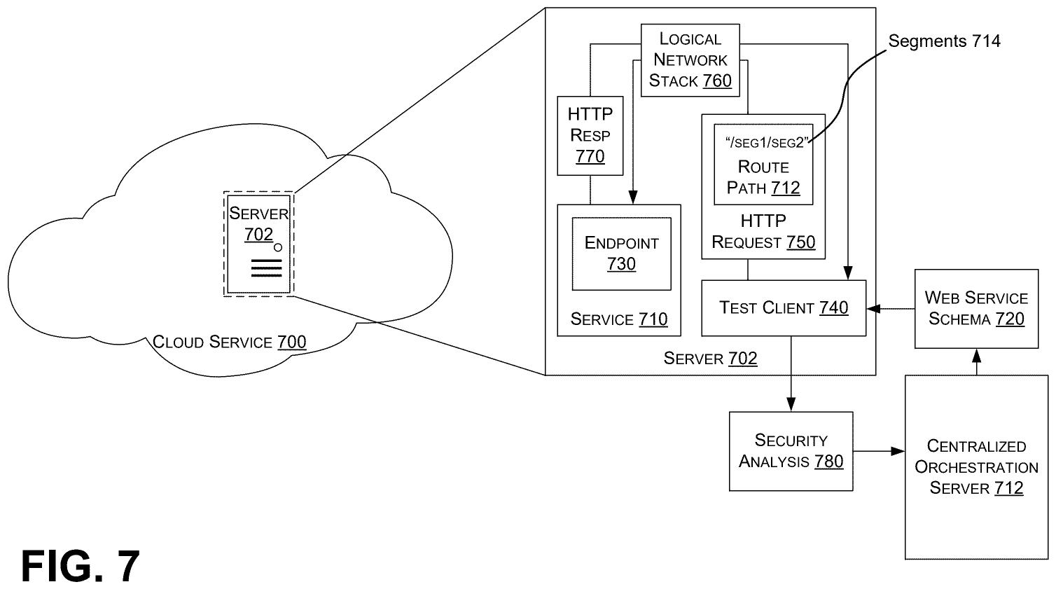

FIG. 7 illustrates co-locating a dynamic web service test client on the same computing device that is running the service under test. In some configurations, centralized orchestration server 712 distributes one or more dynamic web service test clients to servers 702 running service 710. Centralized orchestration service 712 may distribute dynamic web service test clients in this way in response to a service owner request. The centralized orchestration server 712 may configure the dynamic web service test clients 740 to test service endpoints 730 that are particular to the server 702 they are deployed to. For example, centralized orchestration server 712 may provide dynamic web service test clients 740 with web service schemas 720 that are particular to or limited to the endpoints 730 co-located on the same server device 702. In some configurations, centralized orchestration server 712 maintains a list of servers 702 running services 710, including which endpoints 730 are exposed by the services 710 running on each server 702.

Cloud service 700 hosts server 702. Server 702 runs service 710 which exposes endpoint 730. Server 702 also runs test client 740, which includes or receives web service schema 720. Web service schema 720 may be in the form of a Swagger or OpenAPI schema format that describes the endpoints and their API parameters exposed by service 710. This allows test client 740 to generate HTTP request 750 for endpoint 730. Test client 740 may generate HTTP request 750 to include route path 712. Segments 714 of route path 712 may be selected to perform a security analysis on endpoint 730.

Test client 740 sends HTTP request 750 through logical network stack 760 without sending any data over an external network. In response to HTTP request 750, endpoint 730 of service 710 provides HTTP response 770. HTTP response 770 also travels through logical network stack 760 back to test client 740. Test client 740 may perform a security analysis or other type of analysis on how HTTP request 750 was processed, including analyzing the contents of HTTP response 770. This analysis may be provided as security analysis 780 to centralized orchestration server 712 for aggregation and further review.

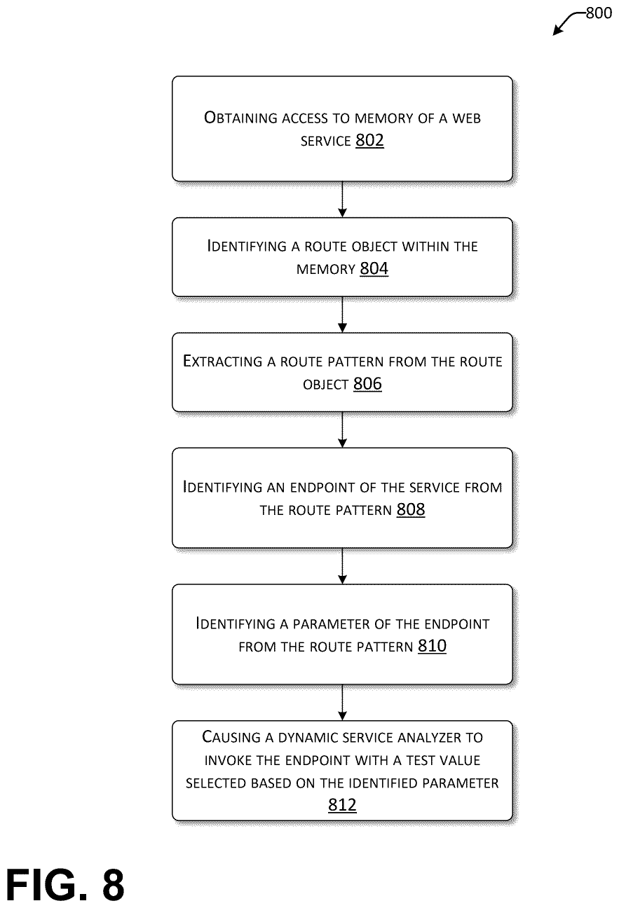

FIG. 8 is a flow diagram of an example method of application security testing. Routine 800 begins at operation 802, access to memory 112 of service 110 is obtained. Memory 112 may be obtained by direct access such as injecting a bootstrap dynamic link library, using debug or profiling APIs, or by taking a memory snapshot.

Routine 800 continues at operation 804, where route object 122 is identified within memory 112. Route object 122 may be identified by traversing an object graph rooted by web application object 120. Route object 122 may be identified using reflection or other techniques for identifying object types from in-memory object layouts. Additionally, or alternatively, route object 122 may be found within the object graph based on a hard-coded location within the object graph.

Routine 800 continues at operation 806, where route pattern 222 is extracted from route object 122.

Routine 800 continues at operation 808, where endpoint 226 is identified from route pattern 222. When service 110 is implemented using a compatible architecture such as MVC, endpoint 226 may be identified by inferring a particular action 230 of a particular controller 224 from route pattern 222.

Routine 800 continues at operation 810, where parameter 240 of the identified action 230 of the particular controller 224 is inferred from route pattern 222.

Routine 800 continues at operation 812, where a dynamic service analyzer tool invokes the identified endpoint 226 with a test value, wherein the test value is selected based on the identified action 230, including parameter(s) 240, of the particular controller 224.

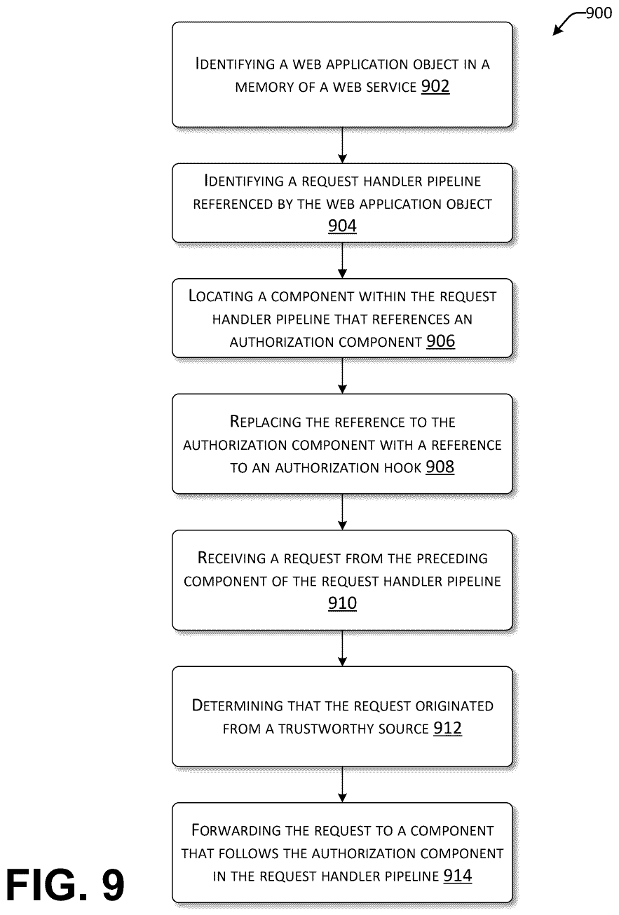

FIG. 9 is a flow diagram of an example method of application security testing. Routine 900 begins at operation 902, wherein a web application object 420 is identified in memory 412 of web service 402.

Routine 900 continues at operation 904, where request handler pipeline 422 is identified within web application object 420. Request handler pipeline 422 may be identified by name in a defined location of an object graph rooted by web application object 420.

Routine 900 continues at operation 906, where a component that precedes authorization component 444 is identified within request handler pipeline 422. The preceding component may be authentication component 442, but in other configurations the preceding component may be any other type of component. The preceding component may be identified by traversing request handler pipeline 422 until a component that references authorization component 444 as a next component is found.

Routine 900 continues at operation 908, where the reference to authorization component 444 is replaced with a reference to authorization hook 544.

Routine 900 continues at operation 910, where request 430 is received by authorization hook 544 from the preceding component.

Routine 900 continues at operation 912, authorization hook 544 determines that request 430 originated from trustworthy source 450. This determination may be made based on an ephemeral secret 431 stored in request 430. This determination may also be made based on where request 430 originated, such as if it originated from a known IP address, a local IP address, or some other provably safe source.

Routine 900 continues at operation 914, where authorization hook 544 forwards request 430 to a component that followed authorization component 444 of request handler pipeline 422. In this way, authorization is bypassed for request 430. Alternatively, if authorization hook 544 cannot establish that request 430 originates from a trustworthy source, then request 430 is forwarded to authentication component 444 for routine authorization processing.

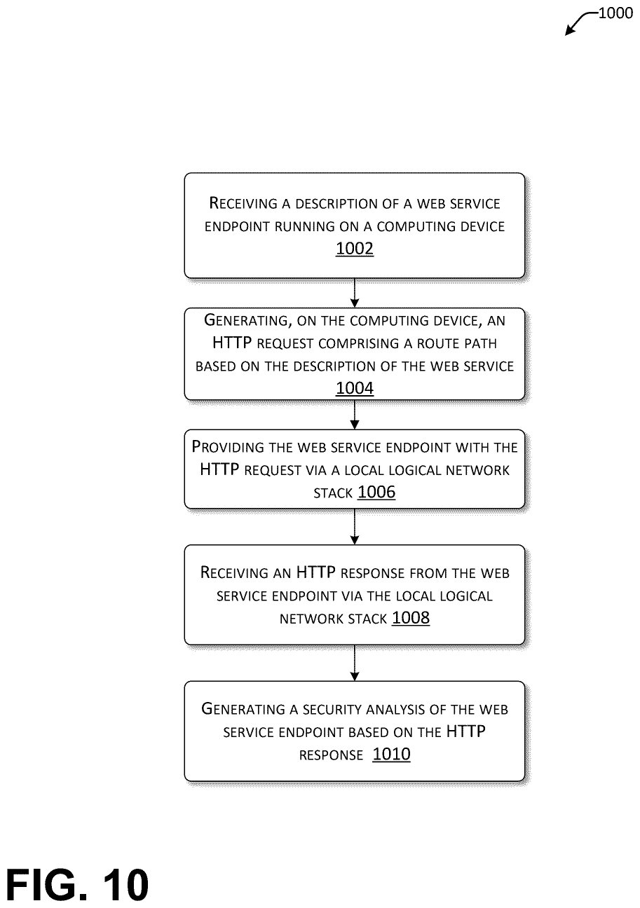

FIG. 10 is a flow diagram of an example method of application security testing. Routine 1000 begins at operation 1002, where a description of a web service endpoint running on a computing device is received. For example, web service schema 720 may be received from centralized orchestration server 712.

Routine 1000 continues at operation 1004, where a synthetic HTTP request 750 is generated by test client 740 based on web service schema 720. HTTP request 750 may be constructed to test some aspect of service 710, such as whether sensitive data can be made to leak from service 710, whether service 710 can be made to crash or consume an inordinate amount of resources, etc.

Routine 1000 continues at operation 1006, where HTTP request 750 is provided to service 710 via a local logical network stack 760. Leveraging on-device network stack 760 avoids the equipment costs of running test client 740 on a dedicated client device. It also significantly reduces network lag caused by communicating between devices.

Routine 1000 continues at operation 1008, where HTTP response 760 is received by test client 740 from service 710. HTTP response 770 is communicated to test client 740 over local logical network stack 760, saving on equipment and networking costs compared to tests initiated by a remote computing device.

Routine 1000 continues at operation 1010, where a security analysis of web service endpoint 710 is generated based on HTTP response 770.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routines 800, 900, and 1000 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routines 800, 900, and 1000 may be also implemented in many other ways. For example, the routines 800, 900, and 1000 may be implemented, at least in part, by a processor of another remote computer or a local circuit. In addition, one or more of the operations of the routines 800, 900, and 1000 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

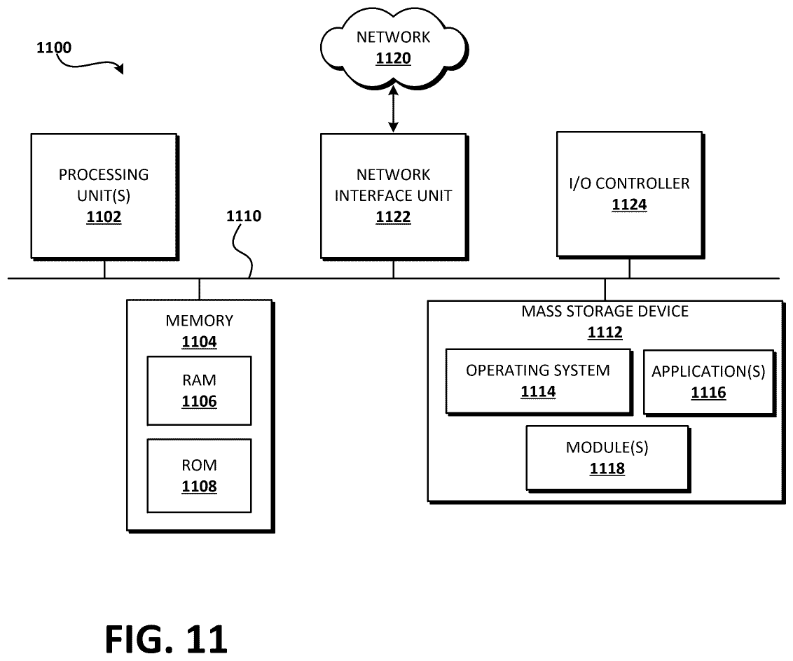

FIG. 11 shows additional details of an example computer architecture 1100 for a device, such as a computer or a server configured as part of the systems described herein, capable of executing computer instructions (e.g., a module or a program component described herein). The computer architecture 1100 illustrated in FIG. 11 includes processing unit(s) 1102, a system memory 1104, including a random-access memory 1106 (“RAM”) and a read-only memory (“ROM”) 1108, and a system bus 1110 that couples the memory 1104 to the processing unit(s) 1102.

Processing unit(s), such as processing unit(s) 1102, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), Neural Processing Unites (NPUs) etc.

A basic input/output system containing the basic routines that help to transfer information between elements within the computer architecture 1100, such as during startup, is stored in the ROM 1108. The computer architecture 1100 further includes a mass storage device 1112 for storing an operating system 1114, application(s) 1116, modules 1118, and other data described herein.

The mass storage device 1112 is connected to processing unit(s) 1102 through a mass storage controller connected to the bus 1110. The mass storage device 1112 and its associated computer-readable media provide non-volatile storage for the computer architecture 1100. Although the description of computer-readable media contained herein refers to a mass storage device, it should be appreciated by those skilled in the art that computer-readable media can be any available computer-readable storage media or communication media that can be accessed by the computer architecture 1100.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 1100 may operate in a networked environment using logical connections to remote computers through the network 1120. The computer architecture 1100 may connect to the network 1120 through a network interface unit 1122 connected to the bus 1110. The computer architecture 1100 also may include an input/output controller 1124 for receiving and processing input from a number of other devices, including a keyboard, mouse, touch, or electronic stylus or pen. Similarly, the input/output controller 1124 may provide output to a display screen, a printer, or other type of output device.

It should be appreciated that the software components described herein may, when loaded into the processing unit(s) 1102 and executed, transform the processing unit(s) 1102 and the overall computer architecture 1100 from a general-purpose computing system into a special-purpose computing system customized to facilitate the functionality presented herein. The processing unit(s) 1102 may be constructed from any number of transistors or other discrete circuit elements, which may individually or collectively assume any number of states. More specifically, the processing unit(s) 1102 may operate as a finite-state machine, in response to executable instructions contained within the software modules disclosed herein. These computer-executable instructions may transform the processing unit(s) 1102 by specifying how the processing unit(s) 1102 transition between states, thereby transforming the transistors or other discrete hardware elements constituting the processing unit(s) 1102.

The present disclosure is supplemented by the following example clauses:

Example 1: A method comprising: obtaining access to a memory of a computing device allocated to a service; identifying a route object within the memory, wherein the route object forwards individual requests to individual request handlers; extracting a route pattern from the route object; identifying an endpoint of the service from the route pattern; and identifying a parameter of the endpoint from the route pattern.

Example 2: The method of example 1, further comprising: causing a dynamic security scanner to invoke the endpoint, wherein the invocation includes a test value selected based on the identified parameter.

Example 3: The method of example 1, further comprising: generating a specification that describes the service, wherein the specification includes a description of the endpoint and a description of the parameter.

Example 4: The method of example 1, further comprising: identifying the service as one of a plurality of services running on a server device.

Example 5: The method of example 1, wherein access to the memory allocated to the service is obtained by taking a snapshot of the memory allocated to the service while the service is running.

Example 6: The method of example 1, further comprising: receiving, from a centralized orchestration server, a web service schema; generating, on the computing device, an HTTP request derived from the web service schema, wherein the HTTP request includes a route path that includes one or more route path segments; providing the web service endpoint with the HTTP request over a logical network stack; receiving an HTTP response from the web service endpoint over the logical network stack; and generating a security analysis of the web service endpoint based on the HTTP response.

Example 7: The method of example 1, further comprising: injecting an authorization hook between an authentication component and an authorization component of a request handler pipeline of the service, wherein the authorization hook: receives a request from the authentication component; determines that the request originated from a trustworthy source; and forwards the request to a component that follows the authorization component in the request handler pipeline.

Example 8: A system comprising: a processing unit; and a computer-readable storage medium having computer-executable instructions stored thereupon, which, when executed by the processing unit, cause the processing unit to: obtain access to a memory allocated to a web service;

identify a route object within the memory, wherein the route object forwards individual web requests to individual web request handlers; extract a route pattern from the route object; identify an endpoint of the web service from the route pattern; identify a parameter of the endpoint from the route pattern; and cause a dynamic service analyzer to invoke the endpoint with a test value selected based on the identified parameter.

Example 9: The system of example 8, wherein the computer-executable instructions cause the processing unit to: find a root object of the web service; enumerate descendent objects of the root object; and identify the route object as one of the descendent objects having a route object type.

Example 10: The system of example 9, wherein the identified route object is one of a plurality of route objects associated with the web service, and wherein a plurality of endpoints exposed by the web service are identified from one or more of the plurality of route objects.

Example 11: The system of example 10, wherein the computer-executable instructions cause the processing unit to: generate a specification that describes the web service, wherein the specification includes a description of the plurality of endpoints.

Example 12: The system of example 8, wherein the route pattern maps a path segment variable to a route handler variable, and wherein at least a portion of the endpoint of the web service comprises a name of one of a plurality of route handlers that are compatible with the route handler variable.

Example 13: The system of example 8, wherein the route pattern maps a first path segment variable to a controller variable and a second path segment variable to an action variable, and wherein at least a portion of the endpoint of the web service comprises a name of an individual action of an individual controller that is compatible with the controller variable and the action variable.

Example 14: The system of example 13, wherein identifying the parameter of the endpoint from the route pattern comprises identifying a path segment variable or an HTTP header variable or content found in an HTTP body associated with a parameter variable of the action variable, wherein the parameter of the endpoint has a name and a type of an individual parameter that is compatible with the parameter variable.

Example 15: A computer-readable storage medium having encoded thereon computer-readable instructions that when executed by a processing unit causes a system to: identify, in a memory of a service running on a computing device, an application object; identify a request handler pipeline referenced by the application object, wherein the request handler pipeline comprises a sequence of request handler components; locate a preceding component within the sequence of request handler components that includes a reference to an authorization component; replace the reference to the authorization component with a reference to an authorization hook, wherein the authorization hook: receives a request from the preceding component; determines that the request originated from a trustworthy source; and forwards the request to a component that follows the authorization component in the request handler pipeline.

Example 16: The computer-readable storage medium of example 15, wherein determining that the request originated from a trustworthy source comprises determining that the request originated from an untrustworthy source, and wherein forwarding the request to a component that follows the authorization component in the request handler pipeline comprises forwarding the request to the authorization component.

Example 17: The computer-readable storage medium of example 15, wherein the authentication hook modifies the request to indicate that a user making the request has been authenticated and is authorized to access a service endpoint referenced by the request.

Example 18: The computer-readable storage medium of example 15, wherein the request comprises a web request, and wherein determining that the request originated from a trustworthy source comprises determining that a value of an HTTP header of the web request matches a secret value.

Example 19: The computer-readable storage medium of example 15, wherein determining that the request originated from a trustworthy source comprises determining that the request originated from a local computing device.

Example 20: The computer-readable storage medium of example 15, wherein the request is generated on the computing device based on a web service schema received from a centralized orchestration server, wherein the request is provided to the service over a logical network stack, wherein a response to the request is analyzed for security vulnerabilities on the computing device, and wherein the web service schema is generated in part by: obtaining access to the memory of the computing device allocated to the service; identifying a route object within the memory, wherein the route object forwards individual requests to individual request handlers; extracting a route pattern from the route object; identifying an endpoint of the service from the route pattern; and identifying a parameter of the endpoint from the route pattern.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
obtaining access to a memory of a computing device allocated to a service;
identifying a route object within the memory, wherein the route object forwards individual requests to individual request handlers;
extracting a route pattern from the route object;
identifying an endpoint of the service from the route pattern; and
identifying a parameter of the endpoint from the route pattern.

2. The method of claim 1, further comprising:
causing a dynamic security scanner to invoke the endpoint, wherein the invocation includes a test value selected based on the identified parameter.

3. The method of claim 1, further comprising:
generating a specification that describes the service, wherein the specification includes a description of the endpoint and a description of the parameter.

4. The method of claim 1, further comprising:
identifying the service as one of a plurality of services running on a server device.

5. The method of claim 1, wherein access to the memory allocated to the service is obtained by taking a snapshot of the memory allocated to the service while the service is running.

6. The method of claim 1, further comprising:
receiving, from a centralized orchestration server, a web service schema;
generating, on the computing device, an HTTP request derived from the web service schema, wherein the HTTP request includes a route path that includes one or more route path segments;
providing the web service endpoint with the HTTP request over a logical network stack;
receiving an HTTP response from the web service endpoint over the logical network stack; and
generating a security analysis of the web service endpoint based on the HTTP response.

7. The method of claim 1, further comprising:
injecting an authorization hook between an authentication component and an authorization component of a request handler pipeline of the service, wherein the authorization hook:
receives a request from the authentication component;
determines that the request originated from a trustworthy source; and
forwards the request to a component that follows the authorization component in the request handler pipeline.

8. A system comprising:
a processing unit; and
a computer-readable storage medium having computer-executable instructions stored thereupon, which, when executed by the processing unit, cause the processing unit to:
obtain access to a memory allocated to a web service;
identify a route object within the memory, wherein the route object forwards individual web requests to individual web request handlers;
extract a route pattern from the route object;
identify an endpoint of the web service from the route pattern;
identify a parameter of the endpoint from the route pattern; and
cause a dynamic service analyzer to invoke the endpoint with a test value selected based on the identified parameter.

9. The system of claim 8, wherein the computer-executable instructions cause the processing unit to:
find a root object of the web service;
enumerate descendent objects of the root object; and
identify the route object as one of the descendent objects having a route object type.

10. The system of claim 9, wherein the identified route object is one of a plurality of route objects associated with the web service, and wherein a plurality of endpoints exposed by the web service are identified from one or more of the plurality of route objects.

11. The system of claim 10, wherein the computer-executable instructions cause the processing unit to:
generate a specification that describes the web service, wherein the specification includes a description of the plurality of endpoints.

12. The system of claim 8, wherein the route pattern maps a path segment variable to a route handler variable, and wherein at least a portion of the endpoint of the web service comprises a name of one of a plurality of route handlers that are compatible with the route handler variable.

13. The system of claim 8, wherein the route pattern maps a first path segment variable to a controller variable and a second path segment variable to an action variable, and wherein at least a portion of the endpoint of the web service comprises a name of an individual action of an individual controller that is compatible with the controller variable and the action variable.

14. The system of claim 13, wherein identifying the parameter of the endpoint from the route pattern comprises identifying a path segment variable or an HTTP header variable or content found in an HTTP body associated with a parameter variable of the action variable, wherein the parameter of the endpoint has a name and a type of an individual parameter that is compatible with the parameter variable.

15. A computer-readable storage medium having encoded thereon computer-readable instructions that when executed by a processing unit causes a system to:
identify, in a memory of a service running on a computing device, an application object;
identify a request handler pipeline referenced by the application object, wherein the request handler pipeline comprises a sequence of request handler components;
locate a preceding component within the sequence of request handler components that includes a reference to an authorization component;
replace the reference to the authorization component with a reference to an authorization hook, wherein the authorization hook:
receives a request from the preceding component;
determines that the request originated from a trustworthy source; and
forwards the request to a component that follows the authorization component in the request handler pipeline.

16. The computer-readable storage medium of claim 15, wherein determining that the request originated from a trustworthy source comprises determining that the request originated from an untrustworthy source, and wherein forwarding the request to a component that follows the authorization component in the request handler pipeline comprises forwarding the request to the authorization component.

17. The computer-readable storage medium of claim 15, wherein the authentication hook modifies the request to indicate that a user making the request has been authenticated and is authorized to access a service endpoint referenced by the request.

18. The computer-readable storage medium of claim 15, wherein the request comprises a web request, and wherein determining that the request originated from a trustworthy source comprises determining that a value of an HTTP header of the web request matches a secret value.

19. The computer-readable storage medium of claim 15, wherein determining that the request originated from a trustworthy source comprises determining that the request originated from a local computing device.

20. The computer-readable storage medium of claim 15, wherein the request is generated on the computing device based on a web service schema received from a centralized orchestration server, wherein the request is provided to the service over a logical network stack, wherein a response to the request is analyzed for security vulnerabilities on the computing device, and wherein the web service schema is generated in part by:
obtaining access to the memory of the computing device allocated to the service;
identifying a route object within the memory, wherein the route object forwards individual requests to individual request handlers;
extracting a route pattern from the route object;
identifying an endpoint of the service from the route pattern; and
identifying a parameter of the endpoint from the route pattern.
